(19) United States
(12) Patent Application Publication
(10) Pub. No.: US 2013/0167846 A1
(43) Pub. Date: Jul. 4, 2013

(54) Aerobic mouthguard adapted to permit larger oral osmosis while diffusing larger oral shock

(71) Applicant: Edward Patrick Hurley, Sarasota, FL (US)

(72) Inventor: Edward Patrick Hurley, Sarasota, FL (US)

(21) Appl. No.: 13/374,559

(22) Filed: Jan. 3, 2012

(51) Int. Cl. A61C 5/14

(52) U.S. Cl. 128/861

(57) ABSTRACT

An aerobic mouthguard having a plurality of treads intermittent to one of a plurality of recesses forming an oral footprint and or an opposite oral footprint for larger oral shock diffusion and larger oral osmotic equilibrium. Each oral footprint may comprise a plurality of ducts and v-cuts that taper toward their posterior end for retaining larger oral fluids. The aerobic mouthguard can comprise a single rigid footprint for stress related contact sports or a double elastic footprint for stress-free dental therapy and treatment. A tab defining a lip footprint can be forwardly part of the aerobic mouthguard, and a tether or a drool cup having one or more drool pads can be forwardly part of the tab for larger oral osmotic equilibrium to prevent tooth loss.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of dentistry and more specifically to an aerobic mouthguard adapted to permit larger oral osmosis while diffusing larger oral shock.

Various known single and double mouthguards generally have a U-shaped bite pad bridging a set of front and rear bumpers. The single guard has an upper channel or sometimes a lower channel adapted to cover and mostly protect a user's teeth, gums, lips, and jaw. The double guard has a pair of upper and lower channels adapted to cover and protect the user's entire teeth, gums, lips and jaws.

These mouthguards generally come in three commercially available types: custom, formed and stock mouth protectors. Custom mouthguards are considered by the American Dental Association and Academy for Sports Dentistry as the best protection for the teeth, lips and jaw. Made of a vacuum formed ply or pressure laminated multiply layers, these custom guards provide a tighter fit to the user's teeth in comparison to a retail unit.

Formed mouthguards typically have a thermoplastic material, such as ethylene-vinyl acetate (EVA), polyolefin, Kraton and polyurethane. The thermoplastic device is initially heated in boiling water; briefly cooled; and molded between the user's bite for a semi-snug fit. They have decreased retention over time due in large part to the chemistry properties of thermoplastic material.

Stock mouthguards are intended to fit any size mouth. Their inexpensive design affords extra slack to possibly jar or wear them loose and invite injury. Made of rubber or polyvinyl, these pre-formed guards are mostly preferred for immediate use.

Some studies have shown impact properties of mouthguards may be improved by gauging the front bumper between 3-4 mm, bite pad between 3-5 mm and rear bumper between 2-3 mm. These findings suggest that a youth or petite adult might safely wear about a 3×3×2 mm gauge mouthguard and a heavyweight athlete could be better off wearing a 4×5×3 mm gauge mouthguard; however, the retention rate of a single or double mouthguard tends to drop off when the gauge increases and or the channel shortens respectively. Of course, this retention dilemma can be corrected by sound corrugation principles.

Elasticity also plays an important role in mouthguard retention. The weaker bond characteristic of an elastic mouthguard localizes the absorption of impact energy; thus making softer plastic suitable for stress-free cosmetic, dental therapy and oral treatment use. A hard mouthguard will transfer a significant amount of impact energy to its posterior end where the molar teeth can withstand larger shock. For that reason, harder plastic is generally practical for contact sports, tooth fortification and oral surgery use. The dilemma here is that a hard or soft mouthguard can be mass produced using a stock material that is known for being most affordable and least protective, which may further be addressed by sound corrugation principles.

One consequence of using present day mouthguards is that they all have a tendency to attract an oral conservatory called biofilm, which is also associated with denture use. As aeration gets blocked in the pharyngeal airway the aerobic bacteria receive less oxygen and the dental arches become infested with dangerous anaerobic bacteria and their acid waste. This anaerobic bacteria could grow rapidly in the midst of nutrients, minerals, moisture, impurities, body temperature and time; doubling in volume in as little as twenty minutes to the point where it begins to form plaque.

When plaque takes root and is left unchecked, the aerobic bacteria trapped in the oral conservatory are prone to invade the gums, nerve tract, bloodstream or skeletal system for survival; feeding on oxygen enriched nutrients; and depleting plaque building minerals along their infectious path. As a result, the anaerobic bacteria release sulfur dioxide to leave a fowl odor in the user's mouth. Moreover, the mouth often fills up with saliva because of the mouthguard impairment to potentially cause spitting, drooling and dry mouth. Finally, the excess saliva could quickly oxidize sulfur dioxide to form sulfuric acid of the mouth, which could lead to tooth decay and systemic tooth loss.

A few strategies help maintain a healthy tooth structure including a well-balanced diet, plenty of safe drinking water, avoiding toxins, daily hygiene (for example mouth rinsing, brushing, flossing and scraping), and scheduled dental and medical examinations. A dentist will occasionally place time-released antimicrobial medication or oxidative agents below the gum line, and physically scrape the biofilm and tarter from the teeth and root surfaces. There are also laser options and medical treatments available to care for more serious biofilm conditions. None, however, appear sufficient enough to address the rapid growth of biofilm and its multiplying effect from wearing a mouthguard, which defeats the purpose of wearing one to protect teeth.

### BRIEF SUMMARY OF THE INVENTION

Accordingly, a primary object of the invention, which will be described below in further detail, is to provide a new and improved protective mouthguard for overcoming the aforementioned disadvantages.

To achieve this, the invention essentially provides a user an aerobic mouthguard. The primary goal of the inventor's oral devise is to construct at least one oral footprint that is adapted with a plurality of treads intermittent to one of a plurality of recesses, so that each tread can sufficiently diffuse larger oral shock while each recess may provide a fluid volume to permit larger oral osmosis when the aerobic mouthguard is worn.

A second object of the invention is to provide the aerobic mouthguard with, but it is not essential, a plurality of ducts uniformly positioned therethrough to permit larger oxidation and osmosis in the user's mouth. Each duct can be suitably tapered beginning at its posterior opening and ending at its anterior opening to prevent drooling.

A third object of the invention is to provide the aerobic mouthguard with, but it is not essential, a single rigid oral footprint embodiment of the invention, so that it can suitably diffuse larger oral shock when worn in contact sports.

A forth object of the invention is to provide the aerobic mouthguard with, but it is not essential, a double elastic oral footprint embodiment of the invention, so that a clinician can use it to apply uniform dental therapy and treatment and their client can wear it in comfort.

A fifth object of the invention is to provide the aerobic mouthguard with, but it is not essential, a tab extending forwardly therefrom further having a plurality of treads intermittent to one of a plurality of recesses, so as to define a lip footprint adapted to permit larger oral oxidation when the aerobic mouthguard is worn.

A sixth object of the invention is to provide the aerobic mouthguard with, but it is not essential, a removable attachable tether. The tether will removably attach to a head guard, such as a facemask or helmet, without interfering with the inventor's primary goal of improving oral osmosis and oral shock diffusion.

A seventh object of the invention is to provide the aerobic mouthguard with, but it is not essential, an auxiliary drool cup suitably adapted to receive one or more predetermined dental pads, so that one or more dental pads cab be intermediately worn over the tab near the user's lips and held by the drool cup to absorb drool. The predetermined dental pads can be conveniently disposed of after use or sent into a dental clinic for immediate feedback and prescribed treatment.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an aerobic mouthguard adapted to permit larger oral osmosis while diffusing larger oral shock comprising: a U-shaped bite pad bridging a front bumper and a rear bumper inwardly complimentary to a user's maxilla and or sometimes their mandible oral substrates and outwardly complimentary to the user's buccal and lingual oral substrates. Each bumper has an edge tapering in height beginning at its anterior end extending to its posterior end, and the bite pad is tapering in width beginning at its posterior end extending to its anterior end.

The invention further comprises a plurality of treads intermittent to one of a plurality of recesses for defining an oral footprint and or an opposite oral footprint. Each tread is generally having, but it is not essential, a semi-convex shape for increasing the pressure gradient of each oral footprint to thereby diffuse larger shock when the aerobic mouthguard is worn. Each recess is generally having a semi-convex shape capable of defining a fluid volume for decreasing the pressure gradient at the oral footprint to thereby permit larger osmosis when the aerobic mouthguard is worn. The increased pressure gradient at the oral footprint counters the decreased pressure gradient at the oral footprint for permitting oral osmotic equilibrium.

The aerobic mouthguard comprises one or more custom, formed and solid materials or any combination thereof, wherein the oral footprint comprises one or more hard and elastic materials or any combination thereof. The oral footprint comprises one or more inseparable and separable portions or any combination thereof.

The oral footprint preferably comprises, but it is not essential, a plurality of ducts longitudinally defining another fluid volume for lowering the pressure gradient and the liquid thereupon the user's mouth while permitting larger oral osmosis when the aerobic mouthguard is worn. Each duct having means to taper beginning at its anterior end and ending at its posterior end for permitting larger oral oxidation and lesser oral drooling of liquids when the aerobic mouthguard is worn. Each bumper comprises one or more v-cuts at its perimeter edge containing another fluid volume therein for permitting larger oral osmosis and, to a lesser extent, larger oral diffusion of shock when the aerobic mouthguard is worn. Each recess can comprise one or more struts molded of the same material as part of the aerobic mouthguard adapted to diffuse larger oral shock and, to a lesser extent, permit larger oral osmosis at the oral and lip footprints when the aerobic mouthguard is worn.

A single rigid footprint embodiment of the invention comprises a plurality of concentrated treads intermittent to one of a plurality of separated recesses for diffusing larger oral shock, particularly in contact sports, while, to a lesser extent, permitting larger oral osmosis when the aerobic mouthguard is worn. A double elastic footprint embodiment of the invention comprises a plurality of separated recesses intermittent to one of a plurality of concentrated treads for permitting larger oral osmosis, particularly in support of dental therapy and treatment, while, to a lesser extent, diffusing larger shock when the aerobic mouthguard is worn.

The aerobic mouthguard having tab means forwardly attached therefrom. The tab further comprises a plurality of treads intermittent to one of a plurality of recesses so as to define a lip footprint molded of the same material as part of the aerobic mouthguard or secured thereof using an adhesive or other securing technique. The tab adapted to protrude outwardly from the users mouth for hygienically handling the aerobic mouthguard at the tab. Each recess of the lip footprint defining another fluid volume at the lip footprint that tapers beginning at its anterior end and ending at its posterior end for permitting larger oral oxidation and oral fluid retention when the aerobic mouthguard is worn. The tab comprises a connector duct at its anterior portion and one or more duct extensions at its posterior portion joining together with one of the plurality of ducts.

The aerobic mouthguard having tether means made of a single or multi cord materials, such as Nylon. The tether comprises a loop at one end and a plug at the other end, the plug having means to wrap around a head guard, such as a facemask or helmet, and stitch therethrough the loop, in connection with the plug having means to removably attach to the connector duct of the tab for forward support of the aerobic mouthguard therefrom the head guard, the tether worn forwardly therefrom the tab when the aerobic mouthguard is worn without interfering with the inventor's combined goals of oral shock diffusion and oral osmosis.

The aerobic mouthguard having drool cup means made of a lightweight stock, formed or custom plastic material to about conform to the user's lips. The drool cup having a concavo convex body and a tab slot that is central to its concavo convex body. The drool cup having means to be worn over the tab at the tab slot to thereby conform to the user's mouth for diffusing larger shock targeted at the drool cup when the aerobic mouthguard is worn. The drool cup can removably receiving one or more predetermined dental pads. The drool cup and the one or more predetermined dental pads can then be worn integrally over the tab and near the user's lips when the aerobic mouthguard is worn to absorb drool. Each predetermined dental pad having means to be disposed of after use or sent into a dental clinic for determining the biofilm condition of the user. These dental pads having means to absorb oral fluids or release prescribed dental treatments for permitting oral osmotic equilibrium.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic side view of a person's pharyngeal substrate region.

FIG. 2 is a schematic side view of the person wearing the aerobic mouthguard.

FIG. 3 is an elevational front view of the aerobic mouthguard of FIG. 2 according to a double embodiment of the invention.

FIG. 4 is an elevational rear view of the aerobic mouthguard of FIG. 3.

FIG. 5 is a top plan view of the aerobic mouthguard of FIG. 3.

FIG. 6 is a bottom plan view of the aerobic mouthguard of FIG. 3.

FIG. 7 is a perspective view of the aerobic mouthguard according to a single rigid embodiment of the invention.

FIG. 8 is a perspective view of the aerobic mouthguard according to a double elastic embodiment of the invention.

FIG. 9 is a perspective view of the aerobic mouthguard according to a tab embodiment of the invention.

FIG. 10 is a perspective view of the aerobic mouthguard according to a tether embodiment of the invention.

FIG. 11 is an exploded view of the aerobic mouthguard according to a single opposite footprint link to a drool cup embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

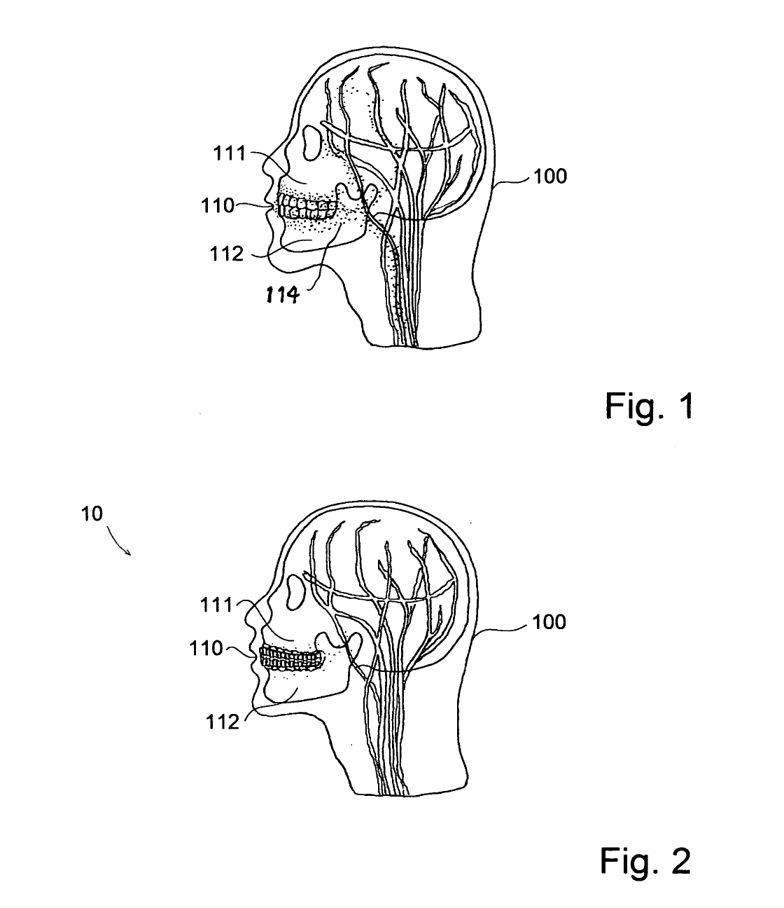

FIG. 1 is a schematic side view of the pharyngeal substrate region 110 of a typical person 100. Prior to mouthguard use, the person's pharyngeal substrate region 110, particularly their maxilla 111 and mandible 112 substrates, tends to harbor nutrients, minerals, moisture, impurities, heat and bacteria to potentially cause biofilm 114. This biofilm could lead to plaque and tooth decay, thus leaving the teeth weaker and more susceptible to tooth breakage and loss.

FIG. 2 is a schematic side view of the pharyngeal region 110 of a person 100 wearing a preferred embodiment of the applicant's aerobic mouthguard 10 that is adapted to permit larger oral osmosis while diffusing larger oral shock.

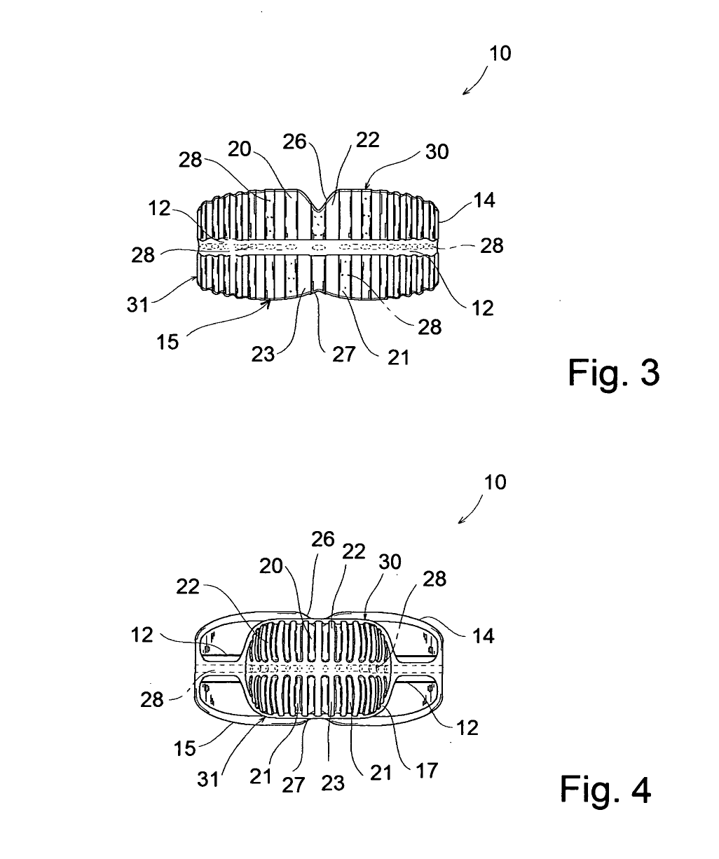

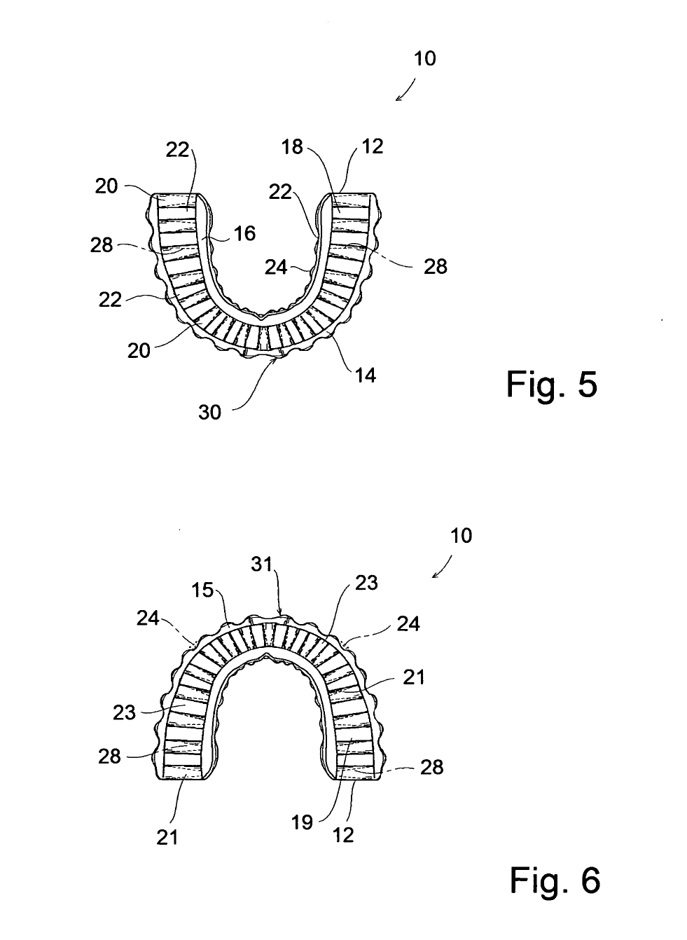

Referring to FIG. 2-6, the aerobic mouthguard 10 comprises a U-shaped bite pad 12 bridging a pair of upstanding front 14 and rear 16 bumpers and or opposite front 15 and rear 17 bumpers to inwardly form an upper channel 18 complimentary to the user's maxilla 111 dental arch and or a lower channel 19 to conform to their mandible 112 dental arch, which is outwardly complimentary to their buccal and lingual substrates respectively. Each of the bumpers 14, 15, 16 and 17 are preferably having an edge tapering in height beginning at its anterior end and extending to its posterior end; whereas, the bite pad 12 is tapering in width beginning at its posterior end and extending to its anterior end. The aerobic mouthguard 10 comprises a plurality of treads 20 intermittent to one of a plurality of recesses 22, so as to define an oral footprint 30; however, the aerobic guard 10 can have a plurality of opposite treads 21 intermittent to one of a plurality of opposite recesses 23, so as to define an opposite oral footprint 31. It can be made of hard and or elastic material; either be constructed of inseparable or separable portions and come as a custom-fitted, form-fitted or stock-fitted oral device. Each tread 20 and 21 is meant to increase the pressure gradient of each oral footprint 30 and 31 for diffusing larger oral shock when the aerobic mouthguard 10 is worn. Each recess 22 and 23 is defining a fluid volume, which is meant to decrease the pressure gradient of each oral footprint 30 and 31, for permitting larger osmosis when the aerobic mouthguard 10 is worn. The increased pressure gradient at each tread 20 and 21 of each respected oral footprint 30 and 31 counters the decreased pressure at each recess 22 and 23 of each respected oral footprint 30 and 31 for permitting oral osmotic equilibrium.

Still referring to the preferred embodiment in FIG. 2-6, each tread 20 and 21 at each front bumper 14 and 15, the bite pad 12 and each rear bumper 16 and 17 is, but it is not essential, made of a semi-convex shape and about gauging 3.5×4.5×2.5 mm in dimensional thickness respectively. And, each recess 22 and 23 at each front bumper 14 and 15, the bite pad 12 and each rear bumper 16 and 17 thereof is, but it is not essential, made of a semi-concave shape and about gauging 2.5×3×1.5 mm in dimensional thickness respectively. Each oral footprint 30 and 31 may allow for, but it is not essential, sixteen treads 20 and seventeen recesses 22 intermittently spaced about 4 mm apart at each front bumper 14 and 15, so as to uniformly taper each tread 20 and 21 and each recess 22 and 23 beginning at each front bumper 14 and 15 and ending at each rear bumper 16 and 17. Additionally, each recess 22 and 23 can have, but it is not essential, a plurality of struts 24, as shown with hidden lines in FIG. 6. These struts 24 can be integrally extended therefrom each recess 22 and 23 to about align with each tread 20 and 21 at its anterior end. Each strut 24 will increase contact with the user's oral substrates, to thereby diffuse larger oral shock and, to a lesser extent, permit larger oral osmosis when the aerobic mouthguard 10 is worn.

Referring again to FIG. 2-6, each oral footprint 30 and 31 can have, but it is not essential, a hard core and an elastic shell adapted for sports use, so that each custom-fit, form-fit or stock-fit tread 20 and 21 therein each chamber 18 and 19 may conform snugly to the users teeth when the aerobic mouthguard 10 is worn; however, their core can be elastic and their shell can be hard. These fitting techniques are widely known in mouthguard manufacturing and will not be disclosed any further. Each bumper 14, 15, 16 and 17 is generally tapered at their perimeter edge beginning at their anterior end and extending to their posterior end for permitting larger oral fluid volume and larger oral osmosis when the aerobic mouthguard 10 is worn. Each oral footprint 30 and 31 can have, but it is not essential, one or more v-cuts 26 near their perimeter edge, which permits a larger oral fluid volume at each v-cut 26, to thereby permit larger oral osmosis and retention of oral liquids when the aerobic mouthguard 10 is worn.

As further referred to in FIG. 2-6, a plurality of ducts 28 can be longitudinally formed therein each tread 20 and 21; however, one or more ducts can also be vertically formed therein the bite pad 12. Each duct 28 at the respected bite pad 12 will align with the user's pharyngeal 110 airway and each duct 28 at each respected bumper 14, 15, 16 and 17 will align with either of their dental arches when the aerobic mouthguard 10 is worn. If the bite pad 12 is longitudinally hinged open at its posterior end (not shown) it is quite possible that each duct may be split open as well. Each duct 28 may have, but it is not essential, a hard core (not shown) material, to which the hard core can be mostly surrounded by an elastic shell (not shown), so that each duct 28 at the respected bite pad 12 will be collapse resistant. Each duct 28 is generally defining a larger fluid volume therein each oral footprint 30 and 31 to thereby permit larger oral breathing and then larger oral oxidation. It will be appreciated that it is in the spirit and scope of this invention that each duct 28 at the respected bite pad 12 is, but it is not essential, tapered beginning at its anterior opening and ending at its posterior opening to permit larger oral oxidation and, to some extent, a back-flow of oral liquids, such as saliva, so as to lessen drooling when the aerobic mouthguard 10 is worn. For example, each duct 28 at the respected bite pad 12 can taper beginning at its posterior end with about a 3 mm circular diameter dimension and end at its anterior end with a 4×2 mm (W×H) oval dimension; however, each duct 28 can be made in any different size and shape; each duct 28 might be omitted; and they may fluid flow in any direction.

The present invention has significant improvement over the prior art which do not provide for oral osmotic equilibrium, which could compound the problem of biofilm and systemic tooth loss. The aerobic mouthguard 10 can be made of hard or elastic corrugated solid, thermoplastic and custom ply type materials or any combination thereof, such as a rigid new generation ethylene copolymer inner core material adhering to a soft rubber-like polyethylene outer shell moldable material, etc. It will be appreciated that the corrugated material used will be of sound or sounder American Dental Association and Academy for Sports Dentistry guidelines related to sports and clinical mouthguards and based on a set of engineering guidelines, such as tensile strength, elongation, tear strength, hardness, impact energy absorption, resistance to impact penetration and fluid sorption of oral substrate materials or better.

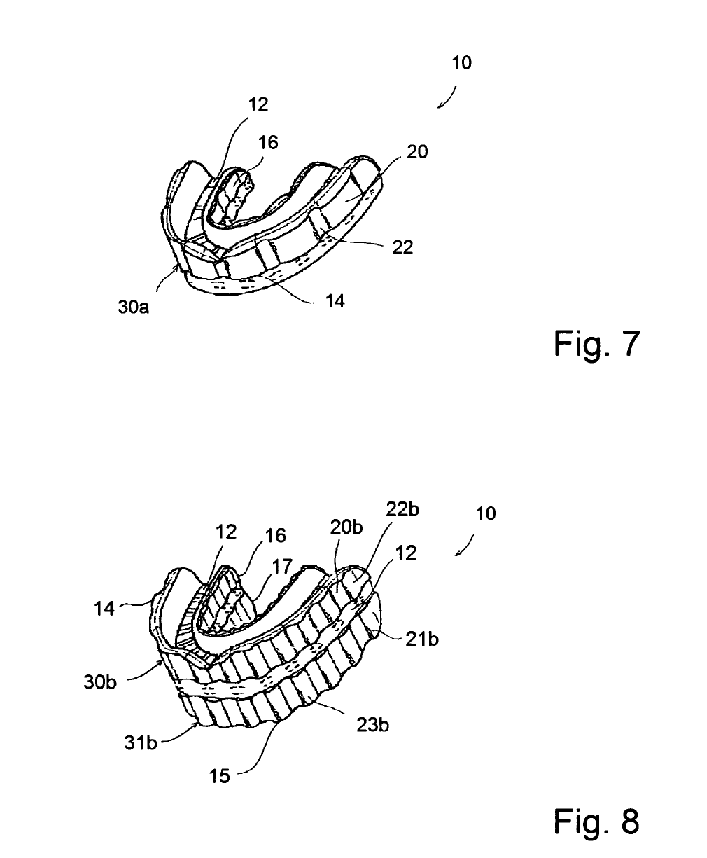

One embodiment of the invention, as described in FIG. 7, includes the aerobic mouthguard 10 described above, but has the opposite footprint 31 omitted and comprises a single rigid oral footprint 30a. Its inner chamber 18 is complimentary to the user's maxilla arch and, to a lesser extent, complimentary to their mandible arch to lend support in contact sports. This rigid footprint 30a can be constructed of custom ply, formed thermoplastic or stock substrate material. It is moderately corrugated; thus making the rigid footprint 30a capable of diffusing larger oral shock at each concentrated tread 20a and, to a lesser extent, capable of permitting larger oral osmosis at each separated recess 22a. This is a direct result of elementary corrugation standards, whereby increasing the average distance of each tread 20a from the neutral axis of the bite pad 12a and each bumper 14a and 16a will serve an athlete well when the single rigid embodiment of the present invention is used for contact sports.

A second embodiment of the invention, as shown in FIG. 8, includes the aerobic mouthguard 10, except that it further comprises a pair of double elastic footprints 30b and 31b; however, a pair of hard double footprints can sometimes substitute for the pair of double elastic footprints 30b and 31b. The double elastic footprints 30b and 31b can be constructed of custom ply, formed thermoplastic or stock substrate material. These double elastic footprints 30b and 31b are more flexible than the single hard footprint 30a to lend clinicians and their clients greater support in dental therapy and treatment. Their recesses 22b and 23b are substantially corrugated to permit larger oral osmosis and larger adhesion of a dental treatment when the aerobic mouthguard 10 is worn. The larger osmosis and adhesion of the double elastic footprint 30b and 31b is a further result of elementary corrugation standards, whereby increasing the average distance of each recess 22b and 23b from the neutral axis of each bumper will serve a clinician and their client well when the double elastic embodiment of the present invention is used for dental therapy and treatment.

Referring again to FIG. 7-8, the single rigid footprint 30a and double elastic footprints 30b and 31b will afford a larger strength to weight ratio, improve airflow and cooling characteristics and eliminate a potential stress concentration according to the physical properties a corrugated medium is known to provide. Because the single rigid footprint 30a and the double elastic footprints 30b and 31b are adapted to simultaneously oxidize and lubricate the user's oral cavity at each recess and each duct, either single or double embodiment of the invention will adhere more firmly against the user's dental arches. And, the single rigid footprint 30a and the double elastic footprints 30b and 31b won't add large amounts of extra material and weight or lengthen the shock response time. Indeed, the single rigid embodiment of the invention is well adapted to stressful contact sports and the double elastic embodiment of the invention is largely meant for stress-free dental therapy and treatment.

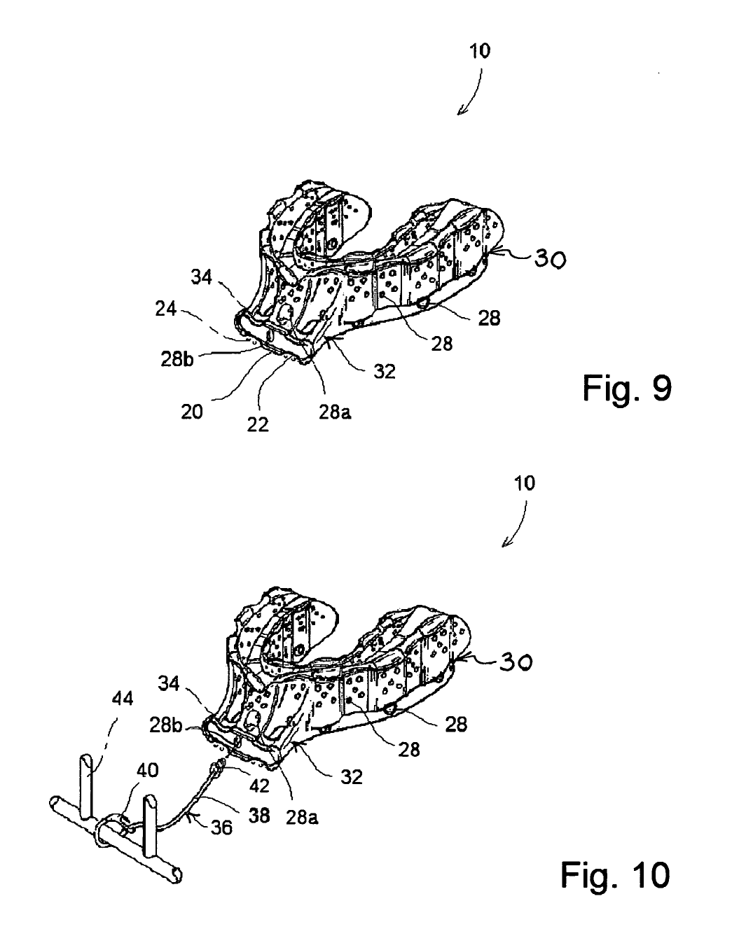

Referring to FIG. 9, a third embodiment of the invention includes the aerobic mouthguard 10, but further includes, but it is not essential, a tab 32 generally attached forwardly therefrom. Preferably, the tab 32 is made of elastic custom ply, formed or stock material or any combination thereof, so as to absorb immediate shock at the tab 32. The tab 32 is integrally molded as part of the aerobic mouthguard 10; however, the tab 32 might be secured to the aerobic mouthguard 10 using a bonding adhesive or other securing technique. The tab 32 preferably has an oblong shape of about 2×2×8 cm dimension (L×W×H) generally complimentary to the user's lips; however, the tab 32 can have a smaller outside dimension depending on the smaller size of the youth or adult wearer. Each respected recess 21 at the respected tab 32 may include, but it is not essential, at least one strut 24, to thereby permit larger saliva retention in the oral cavity when the tab 32 is worn together with the aerobic mouthguard 10. The tab 32 includes a plurality of treads 20 intermittent to one of a plurality of opposite recesses 22, so as to define a lip footprint 34. The lip footprint 34 is complimentary to the user's lips at each of its respected treads 20 and adapted to permit larger oral oxidation while permitting larger saliva retention at each of its respected recess 22. In use, the tab 32 can also be hygienically managed to prevent the spread of biofilm.

Still referring to FIG. 9, the tab 32 can further have one or more duct extensions 28a joining together with one duct 28 extending forwardly therefrom. Each extension duct 28a can be made of a plurality of shapes and sizes, to thereby permit larger oral oxidation when the tab 32 is worn together with the aerobic mouthguard 10. The tab 32 also comprises a connector duct 28b that is adapted to connect the tab 32 to one or more forwardly objects.

Referring to FIG. 10, a forth embodiment of the invention includes the aerobic mouthguard 10, but it is further including, but it is not essential, a tether 36. The tether 36 comes removably attachable to the tab 32; however, the tether can come as an integral part of the aerobic mouthguard 10. Preferably, the tether 36 is made of a custom, formed or stock cord type body 38, such as Nylon, etc., to which the tether 36 has a loop 40 at one end of its body 38 and a plug 42 at the other end of its body 38. The tether 36 will wrap around a nearby protective head guard 44, such as a facemask or helmet; then the plug 42 will stitch therethrough the loop 38; and then the plug 38 will removably attach to the connector duct 28b, to thereby permit forward support of the aerobic mouthguard 10 therefrom and nearby the head guard 44. The tether 36 can be attached to the tab 32 without interfering with the primary goal of ridding the user's mouth of biofilm and shock.

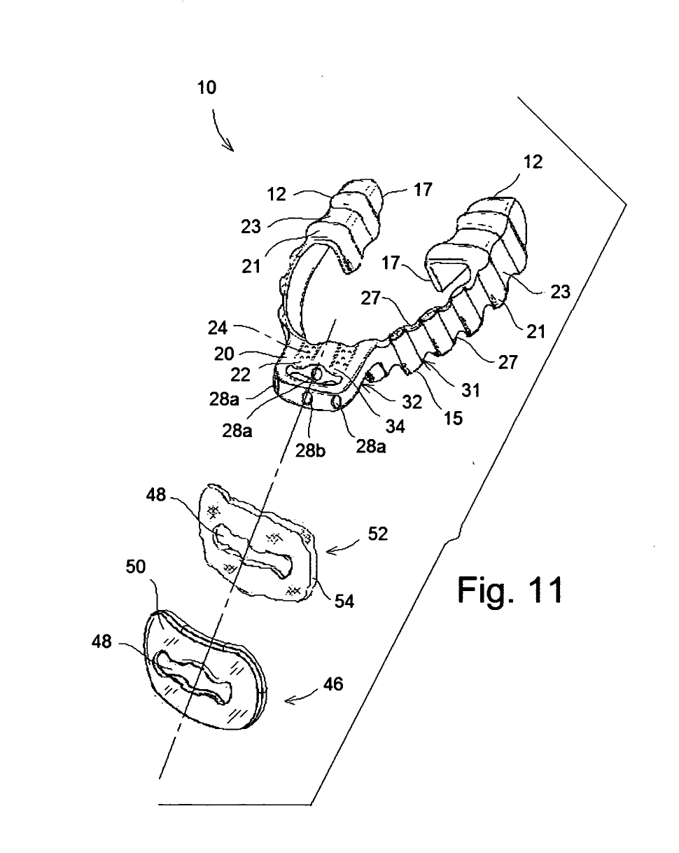

Referring to FIG. 11, a fifth embodiment of the invention includes the aerobic mouthguard 10 and the tab 32 and, but omits the upper oral footprint 30 and an anterior portion of the lower oral footprint 31 and includes a drool cup 46 and one or more predetermined dental pads 52. The drool cup 46 is made of a lightweight custom, formed or stock plastic substrate material and weighs about the same as the aerobic mouthguard 10; however, the drool cup 46 is significantly harder and less permeable than each dental pad 52. This drool cup 46 can removably receive one or more predetermined dental pads 52, such as a standard cotton ball, so as to define an absorbent drool cup. The drool cup 46 and each pad 52 form a tab slot 48 therein adapted to fit over the tab 32 and then hold the drool cup 46 securely over each pad 52 when the drool cup 46 is worn thereupon the tab 32 and near the user's lips for absorbing larger oral shock and drool therein the respective drool cup 46. The pads 52 can be thin dimension with low permeability for mild drooling or large dimension with high permeability for moderate to severe drooling. Once these disposable pads 52 are used, the drool cup 46 can be removed from the tab 32, so that the used pads 52 can be disposed of after use or sent to a dental clinic for further study of the user's oral condition. These pads 52 serve the dental clinician quite well, as they absorb oral fluid or release prescribed dental treatments capable of furthering oral protection to keep teeth healthy and less prone to breakage when the aerobic mouthguard 10 is worn.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An aerobic mouthguard adapted to permit larger oral osmosis while diffusing larger oral shock comprising:
a U-shaped bite pad bridging a front bumper and a rear bumper inwardly complimentary to a user's maxilla and or their mandible oral substrates and outwardly complimentary to their buccal and lingual oral substrates, each of the bumpers having an edge tapering in height beginning at its anterior end and extending to its posterior end, and the bite pad is tapering in width beginning at its posterior end and extending to its anterior end;
a plurality of treads generally having, but it is not essential, a semi-convex shape intermittent to one of a plurality of recesses for defining an oral footprint and or an opposite oral footprint, each tread adapted to increase the pressure gradient at each footprint for diffusing larger shock and each recess defining a fluid volume therein each oral footprint adapted to decrease the pressure gradient at each footprint for permitting larger oral osmosis when the aerobic mouthguard is worn, the increased pressure gradient of the oral footprint counters its decreased pressure gradient for permitting oral osmotic equilibrium.

2. The aerobic mouthguard of claim 1, wherein each oral footprint comprises one or more custom, formed and solid materials or any combination thereof.

3. The aerobic mouthguard of claim 1, wherein each oral footprint comprises one or more hard and elastic materials or any combination thereof.

4. The aerobic mouthguard of claim 1, wherein each oral footprint comprises one or more inseparable and separable portions or any combination thereof.

5. The aerobic mouthguard of claim 1, wherein duct means having means to lower the pressure gradient of each footprint for permitting larger oral osmosis when the aerobic mouthguard is worn.

6. The aerobic mouthguard of claim 5, wherein duct means having means to taper beginning at its anterior end and ending at its posterior end for permitting larger oral oxidation and larger retention of oral fluid, such as saliva, when the aerobic mouthguard is worn.

7. The aerobic mouthguard of claim 1, wherein each bumper having means for one or more v-cuts at its perimeter edge, each v-cut containing a fluid volume therein for permitting larger oral osmosis and, to a lesser extent, larger oral diffusion of shock when the aerobic mouthguard is worn.

8. The aerobic mouthguard of claim 1, wherein each recess comprises one or more struts molded of the same material as part of the aerobic mouthguard adapted to diffuse larger oral shock and, to a lesser extent, permit larger oral osmosis at the oral and lip footprints when the aerobic mouthguard is worn.

9. The aerobic mouthguard of claim 1, wherein a single rigid footprint embodiment of the invention comprises a plurality of concentrated treads intermittent to one of a plurality of separated recesses for diffusing larger oral shock, particularly in contact sports, while, to a lesser extent, permitting larger oral osmosis when the aerobic mouthguard is worn.

10. The aerobic mouthguard of claim 1, wherein a double elastic footprint embodiment of the invention comprises a plurality of separated recesses intermittent to one of a plurality of concentrated treads for permitting larger oral osmosis, particularly in support of dental therapy and treatment, while, to a lesser extent, diffusing larger shock when the aerobic mouthguard is worn.

11. An aerobic mouthguard adapted to permit larger osmosis while diffusing larger oral shock, comprising:
a U-shaped bite pad bridging a front bumper and a rear bumper defining an oral footprint and or an opposite oral footprint inwardly complimentary to a user's maxilla and or their mandible oral substrates and outwardly complimentary to their buccal and lingual oral substrates, each of the bumpers having an edge tapering in height beginning at its anterior end extending to its posterior end, and the bite pad is tapering in width beginning at its posterior end extending to its anterior end;
a plurality of treads generally having, but it is not essential, a semi-convex shape intermittent to one of a plurality of recesses for defining an oral footprint and or an opposite oral footprint, each tread adapted to increase the pressure gradient at each footprint for diffusing larger shock and each recess defining a fluid volume therein each oral footprint adapted to decrease the pressure gradient at each footprint for permitting larger oral osmosis when the aerobic mouthguard is worn, the increased pressure gradient of the oral footprint counters its decreased pressure gradient for permitting oral osmotic equilibrium; and
a tab forwardly attached therefrom the aerobic mouthguard further comprises a plurality of treads intermittent to one of a plurality of recesses so as to define a lip footprint molded of the same material as part of the aerobic mouthguard or secured thereof using an adhesive or other securing technique, the tab extending forwardly therefrom the users mouth for hygienically handling the aerobic mouthguard at the tab, each recess of the lip footprint defining another fluid volume at the lip footprint that tapers beginning at its anterior end and ending at its posterior end for permitting larger oral oxidation and larger saliva retention when the aerobic mouthguard is worn.

12. The aerobic dental guard of claim 9, wherein the tab comprises a connector duct at its anterior portion and one or more extension ducts at its posterior portion joining together with one of the plurality of ducts.

13. The aerobic dental guard of claim 10, wherein the tab having means for a tether, the tether made of a single or multi cord material, such as a Nylon cord, the tether comprises a loop at one end and a plug at the other end, the plug having means to wrap around a head guard, such as a facemask or helmet, and stitch therethrough the loop, in connection with the plug having means to removably attach to the connector duct for forward support of the aerobic mouthguard therefrom the head guard, the tether worn forwardly therefrom the tab when the aerobic mouthguard is worn without interfering with the inventor's combined goals of oral shock diffusion and oral osmosis.

14. The aerobic dental guard of claim 11, wherein the tab having means for a drool cup, the drool cup made of a lightweight stock, formed or custom plastic material, the drool cup having a concavo convex body for about conforming to the user's lips and a tab slot central to its concavo convex body, the drool cup having means to be worn over the tab at the tab slot for diffusing larger lip shock when the aerobic mouthguard is worn.

15. The aerobic dental guard of claim 12, wherein the tab having means for one or more predetermined dental pads, such as a standard cotton pad, intermediate to the drool cup, each predetermined dental pad having means to be worn over the tab near the users lips for absorbing drool and shock, each dental pad having means to be disposed of after use or sent into a dental clinic for determining the biofilm condition of the user, each dental pad having means to absorb oral fluid or release prescribed dental treatment for furthering oral protection.
